(19) United States
(12) Patent Application Publication
(10) Pub. No.: US 2026/0147106 A1
(43) Pub. Date: May 28, 2026

(54) ELECTRONIC DEVICE AND METHOD WITH PERFORMING THE SAME

(71) Applicant: SAMSUNG ELECTRONICS CO., LTD., Suwon-si (KR)

(72) Inventors: Seung Tae KHANG, Suwon-si (KR); Jong Sok KIM, Suwon-si (KR); Ghoo KIM, Suwon-si (KR)

(73) Assignee: SAMSUNG ELECTRONICS CO., LTD., Suwon-si (KR)

(21) Appl. No.: 19/202,523

(22) Filed: May 8, 2025

(30) Foreign Application Priority Data
Nov. 27, 2024 (KR) 10-2024-0172059

(51) Int. Cl. G01S 13/58; G01S 13/02

(52) U.S. Cl. CPC G01S 13/58; G01S 13/0209

(57) ABSTRACT

An electronic device and method with performing the same are provided. The method includes emitting, via a plurality of ultra-wide band (UWB) communication modules, a UWB signal and receiving a UWB signal reflected from one or more surrounding objects; identifying a moving candidate object based on the received UWB signal; determining a position, a velocity, and a classification of the candidate object based on the received UWB signal; identifying a target object that satisfies a predetermined condition, based on at least some of the position, the velocity, and the classification of the candidate object; and activating a target camera corresponding to a position of the target object among a plurality of cameras mounted on a vehicle.

### CROSS-REFERENCE TO RELATED APPLICATIONS

This application claims the benefit under 35 USC § 119(a) of Korean Patent Application No. 10-2024-0172059, filed on Nov. 27, 2024, in the Korean Intellectual Property Office, the entire disclosure of which is incorporated by reference herein for all purposes.

### BACKGROUND

### 1. Field

The following description relates to an electronic device and method with performing the same.

### 2. Description of Related Art

The integration of short-range wireless communication technology into vehicles may enable various convenience features. For example, a vehicle door may be locked or unlocked by bringing a near field communication (NFC) card or a smartphone into contact with the vehicle. Also, remote locking and unlocking may be achieved using ultra-wide band (UWB) wireless communication technology. Moreover, UWB wireless communication technology may facilitate vehicle-to-vehicle (V2V) communication and vehicle-to-infrastructure (V2I) communication, allowing real-time exchange of traffic and road condition information between vehicles or with road infrastructure.

The above information may be presented as a related art to help with the understanding of the disclosure. No arguments or decisions are made as to whether any of the above is applicable as a prior art related to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes emitting, via a plurality of ultra-wide band (UWB) communication modules, a UWB signal and receiving a UWB signal reflected from one or more surrounding objects; identifying a moving candidate object based on the received UWB signal; determining a position, a velocity, and a classification of the candidate object based on the received UWB signal; identifying a target object that satisfies a predetermined condition, based on at least some of the position, the velocity, and the classification of the candidate object; and activating a target camera corresponding to a position of the target object among a plurality of cameras mounted on a vehicle.

The identifying of the candidate object may include performing moving target indication (MTI) on the UWB signal to identify the candidate object.

The received UWB signal may be processed to remove a clutter signal.

The determining of the position, the velocity, and the classification of the candidate object may include determining distances between the candidate object and at least some of the UWB communication modules based on the received UWB signal; and determining the position of the candidate object via multi-lateration using the determined distances.

The determining of the position, the velocity, and the classification of the candidate object may include determining a speed and a heading direction of the candidate object by performing Doppler-processing on the received UWB signal.

The determining of the position, the velocity, and the classification of the candidate object may include determining a radar cross-section (RCS) of the candidate object based on the received UWB signal received; and determining the classification of the candidate object based on the determined RCS.

The determining of the classification may include determining, as a target classification, the classification of the candidate object in response to the RCS falling within a predetermined threshold range.

The identifying of the target object may include identifying the candidate object as the target object in response to a speed of the candidate object satisfying a predetermined first condition and a heading direction of the candidate object satisfying a predetermined second condition.

The identifying of the target object may further include identifying the candidate object as the target object in response to the position of the candidate object further satisfying a predetermined third condition and the classification of the candidate object further satisfying a predetermined fourth condition.

The activating of the target camera may include initiating recording using one or more target cameras each having a photographing region corresponding to the position of the target object.

In one general aspect, provided is a non-transitory computer-readable storage medium storing code that, when executed by one or more processors, configures the one or more processors to perform the method described herein.

In one general aspect, an electronic device includes one or more processors respectively comprising processing circuitry; and a memory comprising one or more storage media and storing code that, when executed by one or more processors, configures the one or more processors to: emit, via a plurality of ultra-wide band (UWB) communication modules, a UWB signal and receive a UWB signal reflected from one or more surrounding objects; identify a moving candidate object based on the received UWB signal; determine a position, a velocity, and a classification of the candidate object based on the received UWB signal; identify a target object that satisfies a determined condition, based on at least some of the position, the velocity, and the classification of the candidate object; and activate a target camera corresponding to a position of the target object among a plurality of cameras mounted on a vehicle.

For the identifying of the candidate object, the one or more processors may be further configured to perform moving target indication (MTI) on the received UWB signal.

The received UWB signal may be processed to remove a clutter signal.

For the determining of the position, the velocity, and the classification of the candidate object, the one or more processors may be further configured to: determine distances between the candidate object and at least some of the UWB communication modules based on the received UWB signal; and determine the position of the candidate object via multi-lateration using the determined distances.

For the determining of the position, the velocity, and the classification of the candidate object, the one or more processors may be further configured to determine a speed and a heading direction of the candidate object by performing Doppler-processing on the received UWB signal.

For the determining of the position, the velocity, and the classification of the candidate object, the one or more processors may be further configured to: determine a radar cross-section (RCS) of the candidate object based on the received UWB signal; and determine the classification of the candidate object based on the determined RCS.

For the determining of the classification of the candidate object, the one or more processors may be further configured to determine the classification of the candidate object as a target classification in response to the RCS falling within a predetermined threshold range.

For the identifying of the target object, the one or more processors may be further configured to identify the candidate object as the target object in response to a speed of the candidate object satisfying a predetermined first condition and a heading direction of the candidate object satisfying a predetermined second condition.

For the identifying of the target object, the one or more processors may be further configured to identify the candidate object as a target object in response to the position of the candidate object further satisfying a predetermined third condition and the classification of the candidate object further satisfying a predetermined fourth condition.

Other features and aspects will be apparent from the following detailed description, the drawings, and the claims.

### BRIEF DESCRIPTION OF THE DRAWINGS

FIG. 1 illustrates an example vehicle control system according to one or more embodiments.

FIG. 2 illustrates an example electronic device according to one or more embodiments.

FIG. 3 illustrates an example control method according to one or more embodiments.

FIGS. 4A and 4B illustrate respective examples method of determining a position of an object according to one or more embodiments.

FIG. 5 illustrates an example method of identifying a target object according to one or more embodiments.

Throughout the drawings and the detailed description, unless otherwise described or provided, it may be understood that the same drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

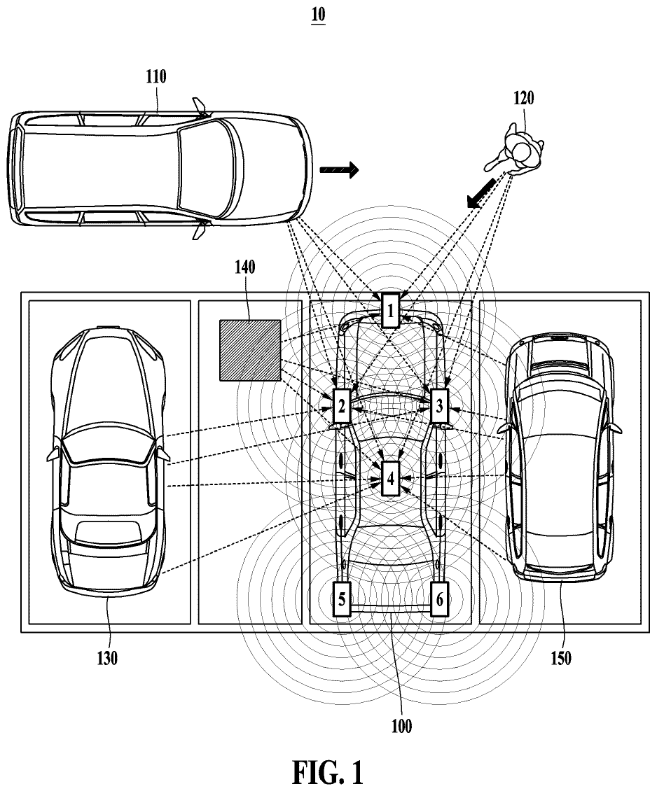

FIG. 1 illustrates an example vehicle control system according to one or more embodiments.

A vehicle control system (e.g., hereinafter, “system”) 10 may include a vehicle 100.

The vehicle 100 may include a communication module configured to establish a direct (e.g., wired) or wireless communication channel between the vehicle 100 and an external server. The communication module supports communication over the established communication channel. In one or more embodiments, the communication module may include a wireless communication module (e.g., a cellular module, a short-range wireless module, and/or a global navigation satellite system (GNSS) module) or a wired communication module (e.g., a local area network (LAN) module and/or a power line communication module). A corresponding one of these communication modules may communicate with an external electronic device and/or an external server via a short-range network (e.g., Bluetooth low energy (BLE), wireless-fidelity (Wi-Fi) direct, near field communication (NFC), and/or infrared data association (IrDA)) or a long-range communication network (e.g., a legacy cellular network, a fifth-generation (5G) network, a next-generation communication network, the Internet, and/or a computer network such as a LAN or a wide area network (WAN)).

In one or more embodiments, the wireless communication module of the vehicle 100 may include a plurality of ultra-wide band (UWB) communication modules 1 to 6. Each of the UWB communication modules 1 to 6 may be a hardware module configured to transmit and receive a UWB signal (or a UWB frequency signal). The number of UWB communication modules 1 to 6 and/or the positions at which the UWB communication modules 1 to 6 are mounted on a vehicle, as illustrated in FIG. 1, are only examples and not limited thereto.

The UWB communication modules 1 to 6 may transmit a UWB signal into the vicinity of the vehicle 100. In one or more embodiments, the vehicle 100 may periodically transmit a UWB scanning pulse to the vicinity of the vehicle 100 via the UWB communication modules 1 to 6.

The UWB communication modules 1 to 6 may also receive a UWB signal. Accordingly, the vehicle 100 may receive a UWB signal through the UWB communication modules 1 to 6.

Based on the UWB signal transmitted and received through the UWB communication modules 1 to 6, the vehicle 100 may perform a communication function with a UWB communication module, an external electronic device, and/or an internal system (e.g., a safety system, a vehicle diagnosis system, and/or a parking assistance system) of the vehicle 100. As a non-limiting example, the system may interface with a smart key or remote control in which an integrated circuit (IC) chip is embedded for UWB communication, a smartphone, a parking sensor, and/or another detection system.

The UWB communication modules 1 to 6 may receive a UWB impulse signal from an external electronic device located in the vicinity of the vehicle 100. For example, the vehicle 100 may receive the UWB impulse signal transmitted in response to a UWB scanning pulse from an external electronic device carried by a driver through at least one or more of the UWB communication modules 1 to 6. The vehicle 100 may determine, based on UWB signal transmission/reception time information, the distance between the driver (or the external electronic device) and the vehicle 100. When the determined distance is less than a predetermined threshold, the vehicle 100 may unlock.

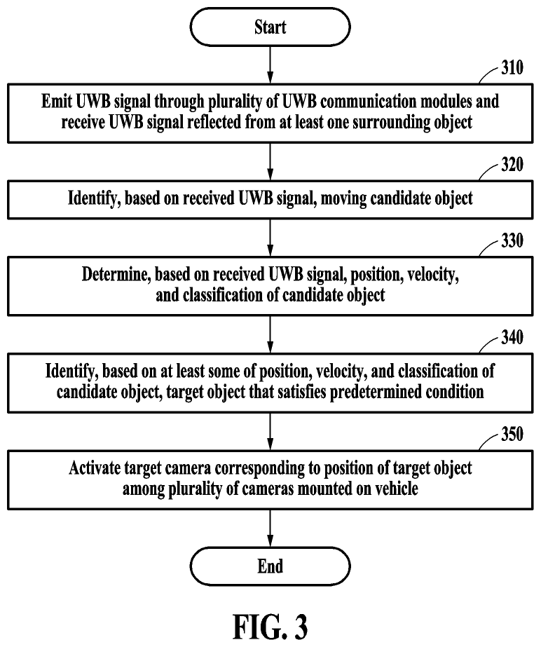

In one or more embodiments, the vehicle 100 may perform a radar function using the UWB signal transmitted and received via the UWB communication modules 1 to 6. The UWB communication modules 1 to 6 may receive/capture UWB signals reflected from objects (e.g., objects 110, 120, 130, 140, and 150) in the vicinity of the vehicle 100. The vehicle 100 may determine positions and classifications (or types) of the objects using the UWB signals. The vehicle 100 may identify moving objects (e.g., objects 110 and 120) and determine their speeds and heading directions based on the received UWB signals. The method of performing a radar function based on a UWB signal is described in detail with reference to FIG. 3.

The vehicle 100 may further include a drive video recording system (DVRS) comprising a plurality of cameras. The vehicle 100 may capture images of the vehicles'surroundings using these cameras and store the captured images. The vehicle 100 may activate the cameras not only when the engine is on (e.g., during driving) but also when the engine is off (e.g., while parked or stationary).

As the number of recording channels increases and image quality improves, the vehicle 100 may activate only a subset of the cameras when a predetermined event (e.g., collision, contact, damage, theft, etc.) occurs or when the possibility of such an event is detected. This selective activation is intended to reduce unnecessary power consumption while the engine is off, thereby preventing battery discharge.

In one or more embodiments, the vehicle 100 may activate one or more cameras using a radar function based on UWB signals. The vehicle 100 may identify a target object that satisfies a determined condition among the objects 110, 120, 130, 140, and 150 in the vicinity of the vehicle 100. The target object may be, for example, an object that may pose a risk to the vehicle 100, such as an external vehicle driving toward the vehicle 100. The method of identifying a target object is described in detail with reference to FIG. 3. The vehicle 100 may activate a target camera corresponding to the target object among the plurality of cameras. For example, the vehicle 100 may activate the target camera whose fields of view correspond to the target object's position/location. For example, the vehicle 100 may activate one or more target cameras whose fields of view corresponding to the current position and the movement direction of the target object.

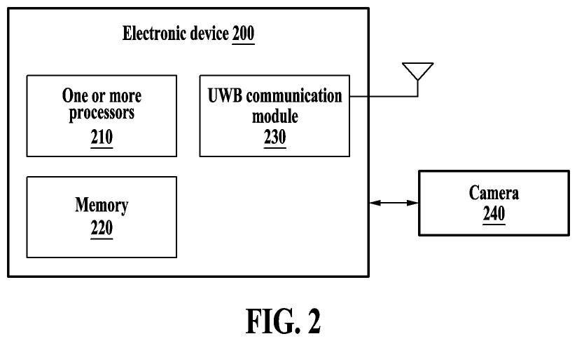

FIG. 2 illustrates an example electronic device according to one or more embodiments.

An electronic device 200 may include one or more processors (hereinafter, referred to as “processors”) 210 respectively including processing circuitry, a memory 220 including one or more storage media for storing instructions (e.g., executable code), and a UWB communication module 230 (e.g., one or more of the UWB communication modules 1 to 6 of FIG. 1). The instructions, when executed by the processors 210 individually or collectively, may configure the processors 210 of the electronic device 200 to perform some or all of the operations described with reference to FIGS. 1 to 5. The vehicle 100 of FIG. 1 may include the electronic device 200.

The electronic device 200 may include a communicator (not shown) that is operatively connected to the processors 210 and the memory 220 for transmitting and receiving data. The communicator may also be connected to an external device to facilitate data exchange. Hereinafter, “transmitting and receiving A” may refer to transmitting and receiving “information or data indicating A”.

The communicator may be implemented as circuitry within the electronic device 200. In one or more embodiments, the communicator may include an internal bus the communicator may also be a component that connects the electronic device 200 to an external device. The communicator may also function as an interface that receives data from an external device and transmits the data to the processors 210 and the memory 220.

The processors 210 may process the data received via the communicator and the data stored in the memory 220. The processors may be each implemented as a hardware-based data processing device having a physical circuit structure to execute desired operations, such as executing code or instructions contained in a program. As a non-limiting example, the hardware-implemented data processing device may include a microprocessor, a central processing unit (CPU), a graphics processing unit (GPU), a processor core, a multi-core processor, a multiprocessor, an application-specific integrated circuit (ASIC), and a field-programmable gate array (FPGA).

The processors 210 may control other components of the electronic device 200 (whether hardware or software) and perform various data processing operations. In one or more embodiments, the processors 210 may store instructions or data received from other components (e.g., via the communicator) into at least a portion of the memory 220, process the stored instructions or data, and then store the resultant data back into the memory 220. Operations performed by the processors 210 may substantially correspond to the overall operations of the electronic device 200.

The memory 220 may store information necessary for the processor 210 to perform processing operations. The memory 220, or one or more storage media included therein, may store instructions/code executed by the processors 210 and may maintain relevant information during the execution of software or programs. For example, the memory 220 may include one or more volatile and/or non-volatile memories known in the art, such as random access memory (RAM), dynamic RAM (DRAM), static RAM (SRAM), non-volatile RAM (NVRAM), persistent memory (PMEM), magneto-resistive RAM (MRAM), high bandwidth memory (HBM), or 3D XPoint.

The electronic device 200 may be connected to external memory through the communicator. For example, the external memory may include one or more types of volatile or non-volatile memories, such as RAM, flash memory, a hard disk drive, and/or an optical disk drive. Such external memory may store a set of instructions (e.g., software) that operate the electronic device 200, with these instructions being executed by the processors 210.

The electronic device 200 may serve as a component for managing an electronic system of a vehicle (e.g., the vehicle 100 of FIG. 1), and may be an electronic control unit (ECU) of the vehicle, as a component incorporated within the ECU, or as a component directly (e.g., via wired or wirelessly connections) connected to the ECU.

The electronic device 200 may include a drive video recording system (DVRS) and be operatively connected to the DVRS. The DVRS of the vehicle may include a camera 240.

The camera 240 of the DVRS may include a plurality of cameras that may be mounted (or installed) at various positions on the vehicle, such as the front, rear, and/or sides. For example, the cameras may be mounted above the rear license plate, on the front bumper, on the rear bumper, on each side pillar, on each front fender, on each side-view mirror, and/or on the front windshield. The around view monitor (AVM) function (also referred to as top view, surround view, or area view) of the vehicle may be integrated with the DVRS, wherein at least some of the cameras of the vehicle may be used for the AVM functionality while the corresponding footage is recorded (or stored) by the DVRS.

The electronic device 200 may control the DVRS to capture and store images of the vehicle's surroundings using the camara 240. The electronic device 200 may activate the camera 240 (or control the DVRS to activate the camera 240) not only when the engine of the vehicle is on (e.g., during driving) but also when the engine of the vehicle is off (e.g., during parking or in a stationary state).

In one or more embodiments where the number of recording channels increases and image quality improves, the electronic device 200 may activate only a subset of the cameras 240 when an event (e.g., collision, contact, theft, etc.) occurs or when the possibility of such an event occurring is detected, in order to reduce unnecessary power consumption while the engine of the vehicle is off. This selective activation reduces unnecessary power consumption during engine-off conditions, thereby preventing battery discharge.

The electronic device 200 may transmit a UWB signal via the UWB communication module 230. In one or more embodiments, the electronic device 200 may periodically transmit a UWB scanning pulse via the UWB communication module 230, and receive the UWB signal transmitted from an external electronic device or reflected from a predetermined object via the UWB communication module 230.

The UWB communication module 230 may be implemented as a UWB integrated circuit (IC) that includes receiver (RX) and transmitter (TX) circuits connected to an antenna, along with a memory, a microcontroller unit (MCU), a signal acquisition module, and a baseband.

In one or more embodiments, the UWB communication module 230 may include a plurality of UWB communication modules, each equipped with an antenna. The UWB communication module 230 may transmit and receive a UWB signal through the antenna. The antenna of the UWB communication module 230 may have, for example, a beamwidth of less than 30°, exactly 30°, between 30° and 60°, exactly 60°, between 60° and 90°, exactly 90°, between 90° and exactly 120°, or 120° or more. The antenna of the UWB communication module 230 may have a beamwidth capable of transmitting and receiving a signal in a substantially omni-directional manner. Depending on the installation position on the vehicle and the beamwidth of the antenna, the UWB communication module 230 may communicate with devices positioned in nearly any direction outside the vehicle.

The electronic device 200 may perform a communication function and/or operation with an external electronic device equipped with a UWB communication module or an IC chip for UWB communication, as well as with an internal system of the vehicle, based on the UWB signal transmitted and received via the UWB communication module 230. In a non-limiting example, the electronic device 200 may include a communication function processing module (not shown) to facilitate these operations.

The electronic device 200 may also perform a radar function and/or operation based on the UWB signal transmitted and received via the UWB communication module 230. In one or more embodiments, the electronic device 200 may perform the radar function and/or operation without modifying components such as the antenna of the UWB communication module 230 or adding additional components such as a separate radar sensor to the UWB communication module 230. For example, the electronic device 200 may include a radar function processing module (not shown) that may determine the positions and classifications (or type) of surrounding objects using UWB signals. The radar function processing module may identify a moving object and determine the speed and heading direction of the moving object. By leveraging the resource of the UWB communication module 230, which is originally installed for internal/external vehicle communication, the electronic device 200 may accurately detect the position and velocity of surrounding objects while optionally activating only the cameras necessary for photographing and recording.

FIG. 3 illustrates an example control method according to one or more embodiments.

The following operations 310 to 350 may be performed by an electronic device (e.g., the electronic device 200 of FIG. 2). The electronic device may include at least some of the components of the electronic device 200 described with reference to FIG. 2. In one or more embodiments, the electronic device may include one or more processors (e.g., the processors 210 of FIG. 2) and a memory (e.g., the memory 220 of FIG. 2). The electronic device may include a plurality of UWB communication modules (e.g., the UWB communication modules 1 to 6 of FIG. 1 or the UWB communication module 230 of FIG. 2).

Operations 310 to 350 may be performed while the engine of a vehicle (e.g., the vehicle 100 of FIG. 1, which includes the electronic device) is in an off state.

In operation 310, the electronic device may emit a UWB signal via the UWB communication modules and receive the UWB signal reflected from at least one surrounding object.

The electronic device may transmit a UWB scanning pulse via the UWB communication modules, and subsequently receive the UWB signal, whether transmitted directly or reflected from at least one surrounding object, via the UWB communication modules.

In operation 320, the electronic device may identify a moving candidate object (or a candidate object which is moving) based on the UWB signal received via the UWB communication modules. The candidate object may be an object in the vicinity of the electronic device (or the vehicle including the electronic device), excluding static elements (e.g., the ground, a wall, a pillar, and/or a stationary vehicle) and/or predetermined source of noise, such as atmospheric turbulence.

The electronic device may perform moving target indication (MTI) on the UWB signal to identify a moving candidate object. In one or more embodiments, the electronic device may perform Doppler processing on the UWB signal to remove a cluster signal. The clutter signal may be a signal reflected from predetermined static elements (e.g., the ground, a wall, a pillar, and/or a stationery vehicle) in the environment surrounding the electronic device (or the vehicle including the electronic device) and/or from predetermined source of noise, such as atmospheric turbulence. By removing the clutter signal from the UWB signals, the electronic device may identify the moving candidate object.

An operation of identifying the candidate object performing MTI on the UWB signal received via the UWB communication modules may be understood as selecting (or filtering) a signal corresponding to a candidate object. In one or more embodiments, the operation of identifying the candidate object may be understood as identifying a signal (or each candidate object) corresponding to each candidate object from a plurality of signals corresponding to a plurality of candidate objects.

In operation 330, the electronic device may determine the position, velocity, and classification of the candidate object based on the UWB signal received via at least some of the UWB communication modules.

### Position Determination Method

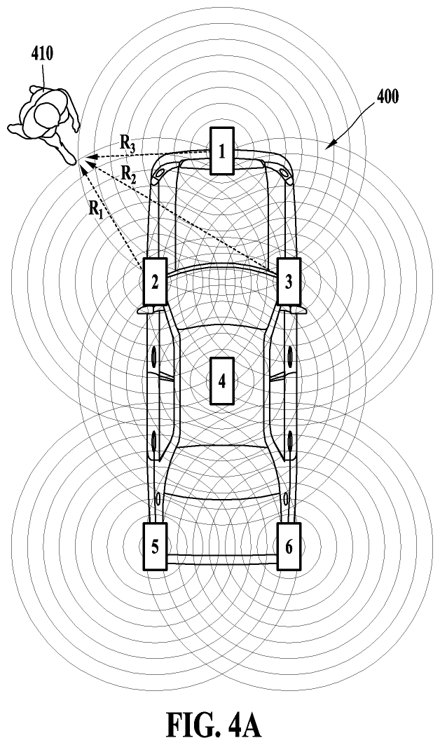

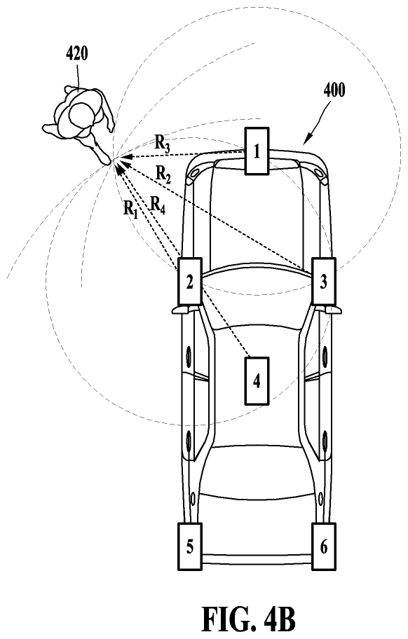

The electronic device may determine the distances between the candidate object and at least some of the UWB communication modules based on the UWB signal received through the at least some of the UWB communication modules. Using multi-lateration based on these distances, the electronic device may determine the position of the candidate object. The method of determining the position of the candidate object is described in detail with reference to FIGS. 4A and 4B.

### Velocity Determination Method

The velocity of the candidate object may include the speed and heading direction of the candidate object. The electronic device may determine the speed and heading direction of the candidate object by performing Doppler-processing on the UWB signal received via at least some of the UWB communication modules. For example, the electronic device may determine the velocity of the candidate object in vector form by performing Doppler-processing on the UWB signal received via at least some of the UWB communication modules.

The electronic device may determine the distances between the candidate object and at least some of the UWB communication modules based on the time delay of the received UWB signal. For example, based on UWB signals received via two or more UWB communication modules, the electronic device may determine the distances between the candidate object and the corresponding UWB communication modules, and may determine a phase difference of each UWB signal based on these distances. The electronic device may further determine the heading direction (or angle of arrival, AOA) of the candidate object using the phase difference and the distances between the corresponding UWB communication modules.

The electronic device may determine the speed and heading direction of the candidate object based on the position of the candidate object, which is determined using the distances between the candidate object and at least some of the UWB communication modules. The electronic device may determine the speed and heading direction of the candidate object according to a change in the position of the candidate object.

### Classification Determination Method

The electronic device may determine a radar cross-section (RCS)(in m²) of the candidate object based on the UWB signal received via at least some of the UWB communication modules. The electronic device may determine the RCS of the candidate object based on the transmission power of the UWB communication module, the antenna gain, the wavelength of the UWB signal, and the distance from the candidate object.

The electronic device may determine the classification (or type) of the candidate object based on the determined RCS of the candidate object. When the RCS of the candidate object falls within a predetermined threshold range, the electronic device may determine the classification of the candidate object as a target classification. The target classification may be an object classification corresponding to, such as an external vehicle, that may pose a risk to the electronic device (or the vehicle including the electronic device).

In one or more embodiments, the electronic device may classify the candidate object as a person when the RCS of the candidate object falls within a first threshold range. When the RCS of the candidate object falls within a second threshold range, the electronic device may classify the candidate object as a vehicle. In this context, the minimum value of the second threshold range may be greater than the maximum value of the first threshold range. When the candidate object is classified as a vehicle, the electronic device may determine the candidate object as a target object.

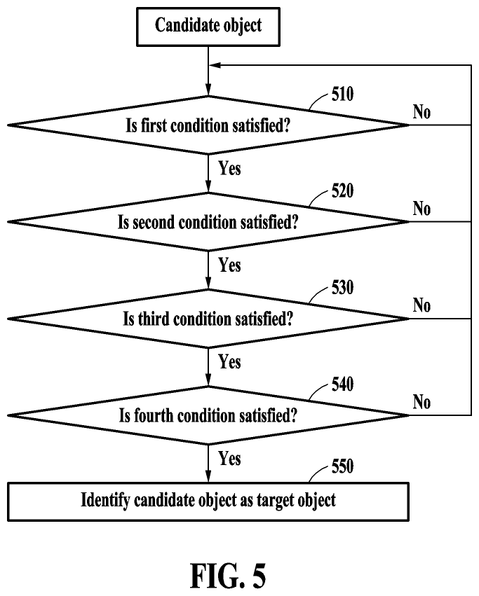

In operation 340, the electronic device may identify the target object that satisfies a predetermined condition, based on at least some of the position, the velocity, and the classification of the candidate object. The method of identifying the target object is described in detail with reference to FIG. 5.

In operation 350, the electronic device may activate a target camera corresponding to the position of the target object among the plurality of cameras mounted on the vehicle. The target camera may be defined as one having a field of view corresponding to the position/location of the target object. Activating the target camera may involve turning on the power of the target camera and initiating or starting recording of the target camera. The electronic device may initiate recording using at least one target camera whose a photographing region aligns with the position of the target object.

For example, the electronic device may activate the target camera that has a photographing region corresponding to the position of the target object among the plurality of cameras. When the position of the target object falls within the photographing regions of two or more cameras, the electronic device may activate some or all of the corresponding cameras.

For example, the electronic device may activate one or more target cameras corresponding to the current position of the target object and the direction in which the target object is moving among the plurality of cameras. The electronic device may also sequentially activate one or more target cameras corresponding to each position of the target object as the position of the target object changes among the plurality of cameras.

As described above with reference to FIG. 2, the electronic device may include a radar function processing module. The electronic device may perform at least some of the operations of FIG. 3 using the radar function processing module. For example, the radar function processing module may enable the electronic device to identify a moving candidate object and determine the position, the velocity, and the classification of the candidate object, based on the UWB signal received through at least some of the UWB communication modules. The radar function processing module may enable the electronic device to finally identify a target object that meets a predetermined condition, based on at least some of the position, the velocity, and the classification of the candidate object.

FIGS. 4A and 4B illustrate respective example method of determining a position of an object according to one or more embodiments.

As described above with reference to FIG. 3, an electronic device (e.g., the electronic device 200 of FIG. 2) included in a vehicle 400 (e.g., the vehicle 100 of FIG. 1) may determine the distances between a candidate object and at least some of the UWB communication modules 1 to 6 based on a UWB signal received via at least some of these modules (e.g., via the UWB communication module 230 of FIG. 2). Using these distances, the electronic device may determine the position of the candidate object through multi-lateration.

In one or more embodiments, the electronic device may determine the position of the candidate object using the distances between the candidate object and at least three of the UWB communication modules 1 to 6.

Referring to FIG. 4A, the electronic device may determine the distance R1 between a candidate object 410 and the UWB communication module 2, the distance R2 between the candidate object 410 and the UWB communication module 3, and the distance R3 between the candidate object 410 and the UWB communication module 1. Based on the positions (or coordinates) of the UWB communication modules 1 to 3, the electronic device may determine the contacts of circles with radii R1, R2, and R3 as the position of the candidate object 410.

Referring to FIG. 4B, the electronic device may determine the distance R1 between a candidate object 420 and the UWB communication module 2, the distance R2 between the candidate object 420 and the UWB communication module 3, the distance R3 between the candidate object 420 and the UWB communication module 1, and the distance R4 between the candidate object 420 and the UWB communication module 4. Based on the positions (or coordinates) of the UWB communication modules 1 to 4, the electronic device may determine the contacts of circles with radii R1, R2, R3, and R4 as the position of the candidate object 420.

The electronic device may determine the position of the candidate object based on at least three UWB communication modules with the shortest distances to the candidate object among the UWB communication modules 1 to 6. The number and/or positions of the UWB communication modules 1 to 6 shown in FIGS. 4A and 4B are provided by way of example and are not intended to be limiting.

FIG. 5 illustrates an example method of identifying a target object according to one or more embodiments.

Operations 510 to 550, as set forth below, may be performed by an electronic device (e.g., the electronic device 200 of FIG. 2). In one or more embodiment, the electronic device may include at least some of the components of the electronic device 200 described with reference to FIG. 2. For example, the electronic device may include one or more processors (e.g., the processors 210 of FIG. 2) and a memory (e.g., the memory 220 of FIG. 2). The electronic device may include a plurality of UWB communication modules (e.g., the UWB communication modules 1 to 6 of FIGS. 4A and 4B and/or the UWB communication module 230 of FIG. 2).

Operation 340 for identifying a target object, as described in FIG. 3, may include operations 510 to 550.

In operation 510, the electronic device may determine whether the speed of the candidate object satisfies a predetermined first condition. The first condition may require that the speed of the candidate object be equal to or greater than (or exceed) a threshold.

In operation 520, the electronic device may determine whether the heading direction of the candidate object satisfies a predetermined second condition. The second condition may require that the heading direction (or a corresponding angle) of the candidate object fall within a threshold angle range based on the electronic device (or the vehicle or a UWB communication module). For example, the second condition may be satisfied when the candidate object moves toward the electronic device (or the vehicle or the UWB communication module), such that the angle between the heading direction of the candidate object and a reference direction (e.g., the front or rear direction of the vehicle, or the direction formed by UWB communication module(s) used to determine the heading of the candidate object) falls within the threshold angle range.

In operation 530, the electronic device may determine whether the position of the candidate object satisfies a predetermined third condition. The third condition may require that the position of the candidate object fall within a threshold radius based on the electronic device (or the vehicle or the UWB communication module). The third condition may be understood as the distance between the candidate object and the electronic device (or the vehicle or the UWB communication module) being equal to or less than the threshold.

In operation 540, the electronic device may determine whether the classification of the candidate object satisfies a predetermined fourth condition. The fourth condition may require that the classification of the candidate object be determined as the target classification. For example, the fourth condition may be a condition in which the candidate object is classified as a target object that may pose a risk to the electronic device (or the vehicle including the electronic device), such as being classified as a vehicle.

When the candidate object satisfies the first, second, third, and fourth conditions, that is, when its speed, heading direction, position, and classification all meet the respective predetermined conditions,, the electronic device may identify the candidate object as the target object.

As illustrated in FIG. 5, the candidate object is identified as the target object when the candidate object satisfies all the four conditions. However, examples are not limited thereto. The electronic device may identify the candidate object as the target object when the candidate object satisfies at least some of the first through fourth conditions.

In one or more embodiments, the electronic device may identify the candidate object as the target object when the speed of the candidate object satisfies the first condition and the heading direction of the candidate object satisfies the second condition. In one or more embodiments, the electronic device may identify the candidate object as the target object when the speed of the candidate object, when moving toward the electronic device, is equal to or greater than (or exceeds) the threshold.

In one or more embodiments, when the speed of the candidate object satisfies the first condition and the position of the candidate object satisfies the third condition, the electronic device may identify the candidate object as the target object. In one or more embodiments, when the candidate object moves at a speed equal to or greater than (or exceeding) a threshold while being positioned within a specified distance from the electronic device (or the vehicle or a UWB communication module), the electronic device may identify the candidate object as the target object.

The sensors, cameras, processors, memories, communication interfaces, electronic devices, modules 1-6 and 230, processors 210, memory 220, camera 240 and other components described herein, including descriptions with respect to respect to FIGS. 1-5, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-5 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
emitting, via a plurality of ultra-wide band (UWB) communication modules, a UWB signal and receiving a UWB signal reflected from one or more surrounding objects;
identifying a moving candidate object based on the received UWB signal;
determining a position, a velocity, and a classification of the candidate object based on the received UWB signal;
identifying a target object that satisfies a predetermined condition, based on at least some of the position, the velocity, and the classification of the candidate object; and
activating a target camera corresponding to a position of the target object among a plurality of cameras mounted on a vehicle.

2. The method of claim 1, wherein the identifying of the candidate object comprises performing moving target indication (MTI) on the UWB signal to identify the candidate object.

3. The method of claim 1, wherein the received UWB signal is processed to remove a clutter signal.

4. The method of claim 1, wherein the determining of the position, the velocity, and the classification of the candidate object comprises:
determining distances between the candidate object and at least some of the UWB communication modules based on the received UWB signal; and
determining the position of the candidate object via multi-lateration using the determined distances.

5. The method of claim 1, wherein the determining of the position, the velocity, and the classification of the candidate object comprises determining a speed and a heading direction of the candidate object by performing Doppler-processing on the received UWB signal.

6. The method of claim 1, wherein the determining of the position, the velocity, and the classification of the candidate object comprises:
determining a radar cross-section (RCS) of the candidate object based on the received UWB signal received; and
determining the classification of the candidate object based on the determined RCS.

7. The method of claim 6, wherein the determining of the classification comprises determining, as a target classification, the classification of the candidate object in response to the RCS falling within a predetermined threshold range.

8. The method of claim 1, wherein the identifying of the target object that comprises identifying the candidate object as the target object in response to a speed of the candidate object satisfying a predetermined first condition and a heading direction of the candidate object satisfying a predetermined second condition.

9. The method of claim 8, wherein the identifying of the target object further comprises identifying the candidate object as the target object in response to the position of the candidate object further satisfying a predetermined third condition and the classification of the candidate object further satisfying a predetermined fourth condition.

10. The method of claim 1, wherein the activating of the target camera comprises initiating recording using one or more target cameras each having a photographing region corresponding to the position of the target object.

11. A non-transitory computer-readable storage medium storing code that, when executed by one or more processors, configures the one or more processors to perform the method of claim 1.

12. An electronic device comprising:
one or more processors respectively comprising processing circuitry; and
a memory comprising one or more storage media and storing code that, when executed by one or more processors, configures the one or more processors to:
emit, via a plurality of ultra-wide band (UWB) communication modules, a UWB signal and receive a UWB signal reflected from one or more surrounding objects;
identify a moving candidate object based on the received UWB signal;
determine a position, a velocity, and a classification of the candidate object based on the received UWB signal;
identify a target object that satisfies a determined condition, based on at least some of the position, the velocity, and the classification of the candidate object; and
activate a target camera corresponding to a position of the target object among a plurality of cameras mounted on a vehicle.

13. The electronic device of claim 12, wherein, for the identifying of the candidate object, the one or more processors are further configured to perform moving target indication (MTI) on the received UWB signal.

14. The electronic device of claim 12, wherein the received UWB signal is processed to remove a clutter signal.

15. The electronic device of claim 12, wherein, for the determining of the position, the velocity, and the classification of the candidate object, the one or more processors are further configured to:
determine distances between the candidate object and at least some of the UWB communication modules based on the received UWB signal; and
determine the position of the candidate object via multi-lateration using the determined distances.

16. The electronic device of claim 12, wherein, for the determining of the position, the velocity, and the classification of the candidate object, the one or more processors are further configured to determine a speed and a heading direction of the candidate object by performing Doppler-processing on the received UWB signal.

17. The electronic device of claim 12, wherein, for the determining of the position, the velocity, and the classification of the candidate object, the one or more processors are further configured to:
determine a radar cross-section (RCS) of the candidate object based on the received UWB signal; and
determine the classification of the candidate object based on the determined RCS.

18. The electronic device of claim 17, wherein, for the determining of the classification of the candidate object, the one or more processors are further configured to determine the classification of the candidate object as a target classification in response to the RCS falling within a predetermined threshold range.

19. The electronic device of claim 12, wherein, for the identifying of the target object, the one or more processors are further configured to identify the candidate object as the target object in response to a speed of the candidate object satisfying a predetermined first condition and a heading direction of the candidate object satisfying a predetermined second condition.

20. The electronic device of claim 19, wherein, for the identifying of the target object, the one or more processors are further configured to identify the candidate object as a target object in response to the position of the candidate object further satisfying a predetermined third condition and the classification of the candidate object further satisfying a predetermined fourth condition.
